(19) United States
(12) Patent Application Publication
(10) Pub. No.: US 2005/0187321 A1
(43) Pub. Date: Aug. 25, 2005

(54) Hard surface cleaning concentrate package and kit

(75) Inventors: Andrew P. Verrall, Crown Point, IN (US); Karen A. Kugler, Porter, IN (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MonoSol, LLC

(21) Appl. No.: 11/104,005

(22) Filed: Apr. 12, 2005

Related U.S. Application Data
(62) Division of application No. 10/375,551, filed on Feb. 26, 2003, now abandoned.

(51) Int. Cl. C08K 5/15

(52) U.S. Cl. 524/236; 524/557; 524/386; 524/109

(57) ABSTRACT

The present invention discloses a water-soluble film suitable for the packaging of hard surface cleaner concentrates for forming a cleaning solution with water. The film includes a water-soluble polymer component and an additive component. The film forms a haze-free solution with water upon dissolving.

### FIELD OF THE INVENTION

This invention relates to water-soluble film, more specifically, to water- soluble film which forms a haze-free solution with water and a hard surface cleaner.

### BACKGROUND OF THE INVENTION

Cleaning hard surfaces, such as glass, is often accomplished through the use of a surface cleaner that is applied directly onto the surface, and then wiped off with a cloth, squeegee, or other means. These types of cleaners often include various combinations of anionic surfactants, nonionic surfactants, amphoteric surfactants, solvents, and chelating agents. Other ingredients often include ammonia, acetic acid, and water.

Because the surface cleaners are generally effective in solution with water, it is possible to have a concentrated cleaner that is mixed with water to form the cleaning solution. The concentrated cleaner may be packaged and shipped separately from the majority of the water component. The end user may then form the concentrate into the final cleaning solution by combining it with water. A problem with the use of concentrated cleaners is they benefit from precise mixing to ensure the proper concentration of surface cleaner in the final cleaning solution. Too dilute of a solution may result in poor performance by the cleaner. Too concentrated a solution may also result in poor performance in that it may leave a residue of the cleaning agent on the cleaned surface. In addition, too concentrated of a cleaning solution results in wasting a portion of the cleaning concentrate.

To prevent improper mixing of the cleaning concentrate, it has been found beneficial to package single use, pre-measured amounts of cleaning concentrate in individual packages. A pre-measured amount of cleaning concentrate is preferably added to a specific volume of water to form a properly concentrated cleaning solution. It is further possible to package the concentrate with a properly sized container such that the user simply adds the cleaning concentrate to the container and fills the remainder of the container with water. When the container is empty, a replacement package of concentrate may be added to the container, and the remainder once again filled with water.

It has been found useful to package certain cleaning concentrates in water-soluble packaging, particularly in single use, pre-measured amounts. Forming the cleaning solution is made easier by the use of water-soluble packaging containing the concentrate because the user may simply add the water-soluble package to a container and then add the correct amount of water to form the desired cleaning solution. As the water-soluble packaging dissolves, the cleaner is released and forms a cleaning solution having the proper concentration of cleaner.

One problem with packaging hard surface cleaning concentrates in water-soluble packaging is that the dissolved packaging may create a haze in an otherwise clear or transparent cleaning solution. It is often desirable that the cleaning solution be dispensed from a clear container 10, which may include a trigger spray mechanism 11 as shown in FIG. 1. Haziness or turbidity in the cleaning solution from the dissolved packaging may result in residue deposited on the surface that is cleaned. Even if no appreciable residue is deposited on the surface during cleaning, when a hazy cleaning solution is placed in a clear container an impression may be created in the mind of the consumer that there will be an undesirable residue left on the cleaned surface.

The present invention has been designed to overcome these and other problems associated with the prior art.

### SUMMARY OF THE INVENTION

According to one aspect of the present invention, a water-soluble film suitable for the packaging of a hard surface cleaner includes a polyvinyl alcohol polymer present in a range of from about 70% to about 95% by weight. The film also includes an additive component present in a range of from about 5% to about 30% by weight. The film has a level of haze-creating materials of less than about 1% by weight.

According to another aspect of the present invention, water-soluble film suitable for the packaging of a hard surface cleaner includes a water-soluble polymer component, a plasticizer component, and a surfactant component. The film forms a haze-free solution with water and the hard surface cleaner having a turbidity in the range of from about 0NTU to about 3.0NTU.

According to another aspect of the present invention, a water-soluble film suitable for the packaging of a hard surface cleaner includes a polyvinyl alcohol polymer, at least one plasticizer, and at least one surfactant. A solution which includes 0.5 g of the film dissolved in 780 ml of a cleaning solution including approximately 1 to 2% by volume of a cleaning concentrate has a turbidity in the range of from about 0NTU to about 3.0NTU. The cleaning solution without the film dissolved in it has a turbidity of about 0.4NTU.

According to another aspect of the present invention, a water-soluble film suitable for the packaging of a hard surface cleaner includes a polyvinyl alcohol component present in a range of from about 70% to about 95% by weight. The film also includes an additive component present in a range of from about 5% to about 30% by weight. A solution which includes 0.5 g of film dissolved in 780 ml of a cleaning solution containing approximately 1% to 2% by volume of a cleaning concentrate has a turbidity in the range of from about 0NTU to about 3.0NTU. The cleaning solution without the film dissolved in it has a turbidity of about 0.4NTU.

### BRIEF DESCRIPTION OF THE DRAWINGS

FIG. 1 is a perspective view of a container having water and an undissolved cleaning concentrate package therein;

FIG. 2 is a perspective view of a cleaning concentrate package according to one embodiment of the present invention;

FIG. 3 is a cross-sectional view of the cleaning concentrate package of FIG. 2 along line 3;

FIG. 4 is a perspective view of a cleaning concentrate package according to another embodiment of the present invention;

FIG. 5 is a perspective view of a cleaning concentrate package according to another embodiment of the present invention; and,

FIG. 6 is a perspective view of a cleaning concentrate package according to another embodiment of the present invention.

### DETAILED DESCRIPTION OF THE INVENTION

While the invention is susceptible of embodiment in may different forms, there is shown in the drawings and will herein be described in detail preferred embodiments of the invention. It is to be understood that the present disclosure is to be considered as an exemplification of the principles of the invention. This exemplification is not intended to limit the broad aspect of the invention to the illustrated and described embodiments.

Hard surface cleaners are commonly used to clean mirrors, windows, counters, tables, appliances, and many other items. The hard surface cleaner is provided in a concentrated form for combining with water to form a cleaning solution. The hard surface cleaners contemplated for use in conjunction with the present invention include any concentrated cleaning agents that form a solution with water in which the solution is clear or transparent. The solution may be colored.

The hard surface cleaner may be solid, gelatinous, or liquid, but is preferably a liquid. Generally, cleaners may include surfactants, solvents, chelating agents, detergents, emulsifiers, dyes, and fragrances, among other things. The cleaner is usually concentrated such that it may be combined with a volume of water to form a cleaning solution that may be applied directly to a surface and then wiped from the hard surface, preferably leaving the surface clean and streak free. The cleaning solution is preferably applied by spraying it directly onto the surface to be cleaned using a container 10 including a trigger spray mechanism 11. While the cleaning concentrate is concentrated to a sufficient degree that it may be combined with water to form a dilute cleaning solution suitable for cleaning, it may initially include water as a component.

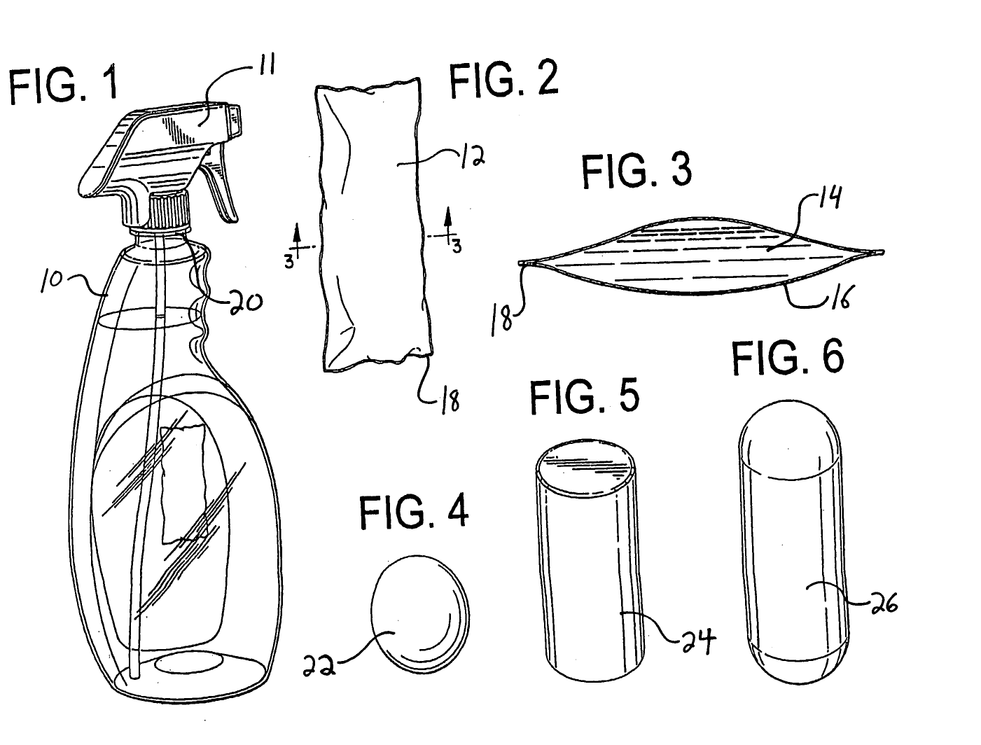

FIG. 2 shows one embodiment of a package 12 for containing a cleaning concentrate. FIG. 3 shows a cross-sectional view of the package 12. The cleaning concentrate 14 is generally sealed in the package 12. The package 12 is preferably formed from webs or sheets of water-soluble film 16 which are preferably bonded along a periphery 18 by heat sealing, solvent bonding, ultrasonic or dielectric welding, or radio frequency sealing. The packages can be configured in various shapes and with various sealing configurations, none of which are particularly preferred. In other embodiments a package may be formed from a continuous web of water-soluble film that is folded and sealed to itself along a periphery of the folded section. There are a variety of packaging machines which can form the filled packages from either one or two film webs. The form of the package 12 is preferably elongated such that it will fit through a neck 20 of the spray bottle as shown in FIG. 1, or other container having a narrowed opening.

Numerous alternative designs and shapes for a cleaner containing package exist, and may be used with the same beneficial results. Some of these are shown in FIGS. 4-6, and include a spherical package 22, a cylindrical package 24, and a capsule shaped package 26. One preferred cleaning system includes packaging a cleaning concentrate in any of the various water-soluble packages described above with a container having a volume such that the package containing the cleaning concentrate may be placed in the container, and the remainder filled with water to provide a haze-free cleaning solution having the proper concentration of cleaning agent. The preferred container is a trigger spray bottle as shown in FIG. 1. The container is preferably reusable and includes a detachable trigger spray mechanism 11, which caps an opening of the container 10. Once all the cleaning solution has been used, another cleaning concentrate package is preferably added to the container, and the remainder filled with water to again form a properly concentrated cleaning solution. Numerous water-soluble packages containing the cleaning concentrate may be packaged with the container to allow the container to be refilled numerous times.

The water-soluble film of the present invention generally creates a haze-free solution with water. The film generally includes three major components; a water-soluble polymer component, a plasticizer component, and a surfactant component. Preferably, the water-soluble film will include only these three components, and will be free of any other additives. Many of the other additives generally present in a water-soluble film cause turbidity when the film is placed with water. Some of the types of additives which are preferably not present in the film include anti-block agents, which prevent adhesion of the surfaces of the film to one another, release agents, lubricants, detackifying agents, fillers, and extenders.

Numerous specific materials generally found in water-soluble films have been shown to contribute to the turbidity of a solution of water and the filrn, and are preferably excluded from a film according to the present invention. These materials may include starches, modified starches, cross-linked polyvinyl pyrrolidone, water-insoluble polymers including polyolefins and polyvinyl acetate among others, cross-linked cellulose ethers, microcrystalline cellulose, chitin, natural and synthetic waxes, certain fatty materials including certain fatty amines, fatty amides, fatty esters including sorbitan fatty acid esters, fatty acids including stearic acid and fatty alcohols, calcium stearate, magnesium stearate, metallic oxides including zinc and aluminum oxides, ground pumice, ground slag, silica, diatomaceous earth, silicates and silicate minerals including talc, mica, and various clays such as kaolin and zeolites, calcium carbonate, magnesium carbonate, calcium sulphate and barium sulfate. These and other additives which cause a haze when placed in solution with water are generally referred to as haze-creating materials herein.

Water-soluble films according to the present invention may include varying amounts of haze-creating materials, a number of which are discussed above. Preferably, the amount of haze-creating material in a water-soluble film according to the present invention will be less than about 1% by weight. More preferably, the amount of haze-creating material will be less than about 0.2% by weight.

The three components preferably present in a film according to the present invention, a water-soluble polymer, a plasticizer, and a surfactant, generally dissolve in water to form a haze-free solution. The water-soluble polymer component is preferably a PVOH resin. The polyvinyl alcohols useful in the present invention may be partially hydrolyzed, and when the polymer is formed from a single monomer, preferably has a degree of hydrolysis in the range of from about 74% to about 90% including all ranges and combination of ranges which are a subset therein.

The PVOH resin used may also be of the copolymer type. Copolymer type PVOH resins may include resins having a degree of hydrolysis of up to 100%. A vinyl alcohol polymer with carboxylate functionality having degrees of hydrolysis up to 100% is also an example of a suitable water-soluble polymer.

The PVOH resins used in the film of the present invention may be of any degree of polymerization. The preferred molecular weights for use in a film according to the present invention include low to medium molecular weight PVOH resins. Preferably, the degree of polymerization is such that a 4% aqueous solution at 20° C. has a viscosity in the range of from about 3 MPa to about 30 MPa including all ranges and combination of ranges which are a subset therein.

The PVOH resin selected is generally present in a range of from about 70% to about 95% by weight including all ranges and combination of ranges which are a subset therein, more preferably in the range of from about 80% to about 88% by weight.

The plasticizer component used in a film according to the present invention is preferably not a haze-creating material. Suitable plasticizers include, but are not limited to glycerin, diglycerin, sorbitol, ethylene glycol, diethylene glycol, triethylene glycol, propylene glycol, polyethylene glycols up to 400 MW, neopentyl glycol, trirnethylolpropane, polyether polyols, ethanolamines, and combinations containing at least one of the listed plasticizers.

The selected plasticizer is preferably present in an amount in the range of from about 5% to about 30% by weight including all ranges and combination of ranges which are a subset therein, more particularly, from about 12% to about 20% by weight.

The third component generally present is a surfactant component. Many different surfactants are suitable for use in a film according to the present invention. The surfactant of choice preferably has a hydrophile-lipophile balance (HLB) value of approximately 10 or higher, more preferably 13 or higher. Especially preferred surfactants are those that have some functionality as release agents, for example combinations of quaternary ammonium compounds and amine oxides. The preferred amount of surfactant in the films is preferably in the range of from about 0.01% to about 1.0% by weight including all ranges and combination of ranges which are a subset therein, more preferably, in the range of from about 0.1% to about 0.6% by weight.

The following examples demonstrate some possible formulations of a film according to the present invention, but are not intended to limit the scope of the invention, which is limited only by the scope of the accompanying claims.

### EXAMPLE 1

| | |
|---|---|
| Polyvinyl Alcohol | 83.0% |
| Glycerin | 16.8% |
| Octylphenol ethoxylate | 0.2% |

### EXAMPLE 2

| | |
|---|---|
| Polyvinyl Alcohol 1 | 40.00% |
| Polyvinyl Alcohol 2 | 40.00% |
| Triethylene Glycol | 19.75% |
| Lauryl/myristyl alcohol | 0.25% |
| ethoxylate | |

### EXAMPLE 3

| | |
|---|---|
| Polyvinyl Alcohol | 83.5% |
| Glycerin | 16.8% |
| Propylene Glycol | 5.0% |
| Lauryl/myristyl alcohol | 0.2% |
| ethoxylate | |
| n-Alkyltrimethylammonium | 0.3% |
| chloride | |

### EXAMPLE 4

| | |
|---|---|
| Polyvinyl Alcohol | 85.7% |
| Glycerin | 14.0% |
| n-Alkyltrimethylammonium | 0.14% |
| chloride | |
| Myristamine oxide | 0.16% |

### EXAMPLE 5

| | |
|---|---|
| Polyvinyl Alcohol 1 | 60.0% |
| Polyvinyl Alcohol 2 | 19.6% |
| Triethylene Glycol | 12.0% |
| Polyethylene Glycol 200 | 8.0% |
| n-Alkyltrimethylammonium | 0.18% |
| chloride | |
| Myristamine oxide | 0.22% |

The example film compositions provided above form haze-free solutions with water. In addition, the films preferably form a solution with water and a cleaning agent that is sufficiently haze-free to clean a hard surface without leaving a residue on the cleaned surface. In addition, such a solution is sufficiently clear such that a consumer will not observe haziness in the solution when it is placed in a clear container.

A solution of dissolved water-soluble film in water should meet a minimum degree of clarity. Tests were performed to measure the results of using a water-soluble film according to the present invention versus using other commercially available water-soluble films in lowering turbidity when the dissolved films are present in a cleaning solution. Example formulations two (2) and three (3), the formulations of which are listed above, were tested against various commercially available PVOH films for turbidity in solution with a cleaning solution. The results shown in the table below clearly demonstrate the benefits of the present invention over the prior art films in lowering turbidity in a solution of dissolved water-soluble film and cleaning concentrate in water.

| FILM | TURBIDITY in |
|---|---|
| (NTU) | Nephelometric Turbidity Units |
| Example 2 Film | 0.87 NTU |
| Example 3 Film | 0.96 NTU |
| Kuraray¹ HH Film | 7.13 NTU |
| Aicello² PT Film | 3.32 NTU |
| Aicello² KB Film | 3.91 NTU |
| Control (Cleaning solution only) | 0.37 NTU |

¹The Kuraray Co. Ltd., Osaka, Japan.
²The Aicello Chemical Co. Ltd., Aichi, Japan.

The test method used to generate the results in the table above first included the preparation of a laboratory prepared all-purpose cleaner concentrate. The cleaner concentrate formulation included:

| | |
|---|---|
| COMPONENT | % BY WEIGHT |

| | |
|---|---|
| Ethylene glycol monobutyl ether | 28% |
| 2:1 diethanolamine-coconut fatty acid condensate | 17% |
| Sodium lauryl sulfate | 26% |
| Tetrasodium EDTA | 23% |
| Water | 6% |

Packages were then constructed of each of the tested water-soluble films, and each was filled with 12 ml of the cleaning concentrate. The film thickness for each of the water-soluble films used in the packages was approximately 73 μm±3 microns. The package dimensions were approximately 13 cm×2 cm, and the approximate mass of the total film in each of the packages was 0.5 g.

Each of the packages was then dissolved in 768 ml of tap water to make solutions having 1.5% by volume of the cleaning concentrate. The cleaning concentrate and dissolved films were allowed to uniformly disperse in the solutions. A 10 ml sample was then removed from each solution for turbidity measurement testing. The device used to measure turbidity for each of the 10 ml samples was a Hach Model 2100AN Laboratory Turbidimeter, calibrated with NIST-traceable standards.

The turbidity measurements shown above demonstrate films according to the present invention allow for the formation of cleaning solutions which are substantially haze-free and have relatively low turbidity measurements. Generally, a solution of water-soluble film according to the present invention, a hard surface cleaner, and water will provide a turbidity measurement of less than about 3.0NTU. More preferably the turbidity measurement of such a solution is less than about 1.0 NTU. The turbidity measurement is, in part, dependent on the cleaning concentrate used to form the cleaning solution, and better clarity may be achieved by selecting a cleaning concentrate having a low turbidity measurement in solution.

It can be appreciated that the testing conducted shows the solutions obtained using the Kuraray and Aicello films were, respectively, approximately nineteen times and ten times more turbid than the control, while the solutions obtained using the films of Examples two (2) and three (3) were only approximately two and one half times more turbid than the control. The reduced turbidity resulted in a cleaning solution having dissolved water-soluble film and cleaning concentrate in a water solution that is substantially haze-free. In a preferred embodiment, the clarity of cleaning solutions formed from a dissolved package containing a cleaning concentrate in accordance with the present invention provides a solution which appears haze-free to the naked eye.

Further turbidity testing of the films of Examples two (2) and three (3) was conducted wherein the films were dissolved only in water without cleaning solution. Solutions were prepared for each of the tested films. The solutions included approximately 0.5 g of film dissolved in 768 ml of tap water making a 0.0065% by weight solution of dissolved film. 10 ml samples of the solutions were tested according to the procedure described above. The turbidity measurement for the solution of Example film two (2) in water was approximately 0.57NTU. The turbidity measurement for the solution of Example film three (3) in water was also approximately 0.57NTU. Both of the solutions appeared clear and haze-free to the naked eye.

While specific embodiments have been illustrated and described, numerous modifications immediately come to mind without significantly departing from the spirit of the invention, the scope of which is limited only by the scope of the accompanying claims.

1. A hard surface cleaning concentrate article, comprising: a single-use water-soluble film package containing a hard surface cleaner,
the film comprising a polyvinyl alcohol present in a range of from about 70% to about 95% by weight, and an additive component present in a range of from about 5% to about 30% by weight, wherein the film has an amount of haze-creating materials of less than about 1% by weight; and
the hard surface cleaner concentrate providing a transparent cleaning solution when diluted for use.

2. The article of claim 1 wherein the amount of haze-creating materials is less than about 0.2% by weight.

3. The article of claim 1 wherein the polyvinyl alcohol is a copolymer.

4. The article of claim 1 wherein the polyvinyl alcohol has a degree of polymerization such that a 4% aqueous solution at 20° C. has a viscosity in the range of from about 3 MPa to about 30 MPa.

5. The article of claim 1 wherein the additive component comprises a surfactant component present in a range of from about 0.01% to about 1.0% by weight.

6. (canceled)

7. The article of claim 1 wherein the additive component comprises an amount of plasticizer present in a range of from about 5% to about 30% by weight.

8. (canceled)

9. A hard surface cleaning concentrate article, comprising: a single-use water-soluble film package containing a hard surface cleaner concentrate,
the film comprising a water-soluble polymer component, a plasticizer component, and a surfactant component;
wherein a solution which includes 0.5 g of the film dissolved in a 780 ml hard surface cleaning solution made from 12 ml of the hard surface cleaning concentrate in water forms a haze-free solution having a turbidity measurement of less than about 3.0 NTU.

10. The article of claim 9 wherein the polymer component is a polyvinyl alcohol.

11. The article of claim 10 wherein the polyvinyl alcohol is of a degree of polymerization such that a 4% aqueous solution at 20° C. has a viscosity in the range of from about 3 MPa to about 30 MPa.

12. The article of claim 10 wherein the polyvinyl alcohol has a degree of hydrolysis in the range of from about 74% to about 90%.

13. The article of claim 9 wherein the plasticizer component is selected from the group consisting of glycerin, diglycerin, sorbitol, ethylene glycol, diethylene glycol, trethylene glycol, propylene glycol, polyethylene glycols up to 400 MW, neopentyl glycol, trimethylolpropane, polyether polyols, ethanolamines, and combinations containing at least one member of said group.

14. The article of claim 9 wherein the amount of plasticizer component is in the range of from about 5% to about 30% by weight.

15. (canceled)

16. The article of claim 9 wherein the amount of surfactant component is in the range of from about 0.01% to about 1.00% by weight.

17-19. (canceled)

20. The article of claim 9 wherein the film has less than about 1% by weight of haze-creating materials.

21. The article of claim 20 wherein the turbidity of the film containing solution is less than about 1.0 NTU.

22-29. (canceled)

30. The article of claim 1, wherein a solution which includes 0.5 g of the film dissolved in a 780 ml hard surface cleaning solution made from 12 ml of the hard surface cleaning concentrate in water has a turbidity of less than about 3.0 NTU.

31-38. (canceled)

39. The article of claim 1, wherein the hard surface cleaning concentrate is a liquid.

40. The article of claim 9, wherein the hard surface cleaning concentrate is a liquid.

41. A hard surface cleaning kit, comprising the packet of claim 1 and a container.

42. The kit of claim 41, wherein the container has a constricted opening and the packet is sized to fit in the constricted opening.

43. The kit of claim 41, wherein the packet and container are sized with respect to each other such that dissolution of the packet in a volume of water equal to the container volume provides a hard surface cleaning solution having a turbidity less than 3.0 NTU.

44. The kit of claim 41, wherein the container is transparent.

45. The kit of claim 41, further comprising a trigger spray mechanism capping an opening of the container.

46. A hard surface cleaning kit, comprising:
a single-use, water-soluble film package containing a hard surface cleaner, the film comprising a polyvinyl alcohol present in a range of from about 70% to about 95% by weight, the polyvinyl alcohol having a degree of polymerization such that a 4% aqueous solution at 20° C. has a viscosity in the range of from about 3 MPa to about 30 MPa, and an additive component present in a range of from about 5% to about 30% by weight, the additive comprising a surfactant component present in a range of from about 0.01% to about 1.0% by weight and a plasticizer present in a range of from about 5% to about 30% by weight, wherein the film has an amount of haze-creating materials of less than about 0.2% by weight; and
a container,
wherein the packet and container are sized with respect to each other such that dissolution of the packet in a volume of water equal to the container volume provides a hard surface cleaning solution having a turbidity less than 3.0 NTU.
